(19) United States
(12) Patent Application Publication
(10) Pub. No.: US 2025/0259522 A1
(43) Pub. Date: Aug. 14, 2025

(54) Early Wildfire Detection and Monitoring System Utilizing Special Radio Communication System

(71) Applicant: David Absalan, Puyallup, WA (US)

(72) Inventor: David Absalan, Puyallup, WA (US)

(21) Appl. No.: 18/438,533

(22) Filed: Feb. 12, 2024

(51) Int. Cl. G08B 17/12; A62C 3/02; G06V 10/70; G06V 20/10; G08B 25/00

(52) U.S. Cl. CPC G08B 17/125; A62C 3/0271; G06V 10/70; G06V 20/188; G08B 17/005; G08B 25/009

(57) ABSTRACT

This system establishes a distributed network of wildfire detection devices designed to provide early warning and facilitate rapid response. Each device is equipped with multiple cameras, including a thermographic camera, allowing for comprehensive image capture and increased detection accuracy. The device is utilizing the power of artificial intelligence to analyze each image taken by the device's multiple cameras and make decisions based on the analyzed results. Additionally, these intelligent devices communicate with neighboring units, exchanging wildfire warnings and extending the effective monitoring area. The system's integrated approach combining image analysis, thermal sensing, and communication capabilities aims to detect wildfire threats as early as possible, ensuring timely mitigation efforts.

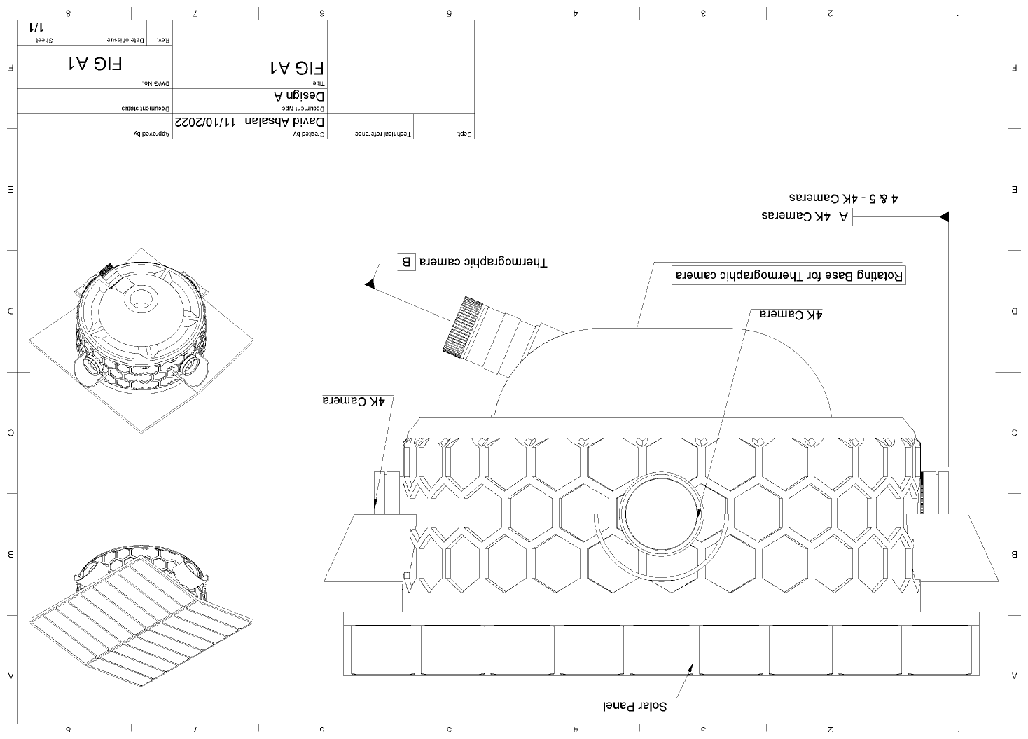

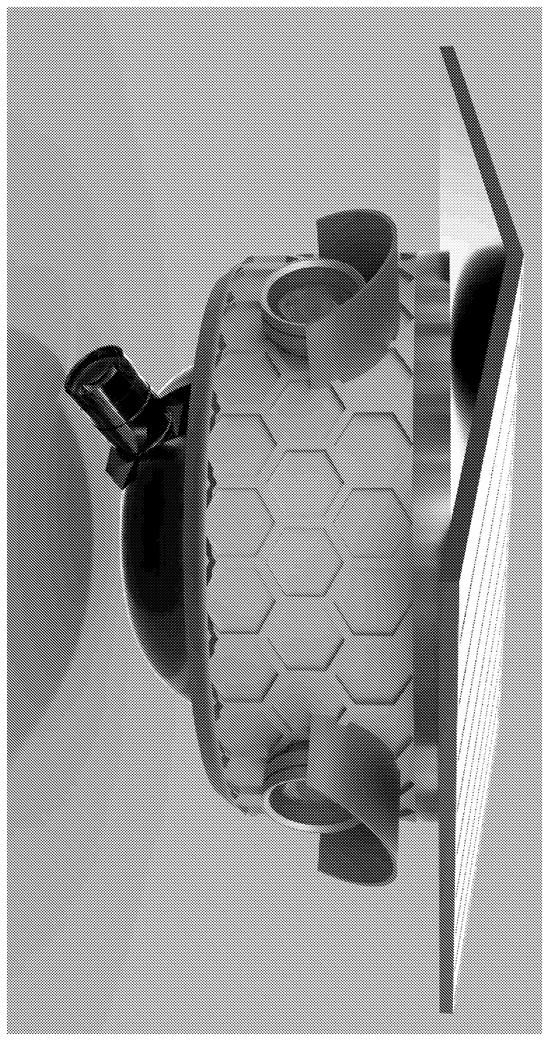

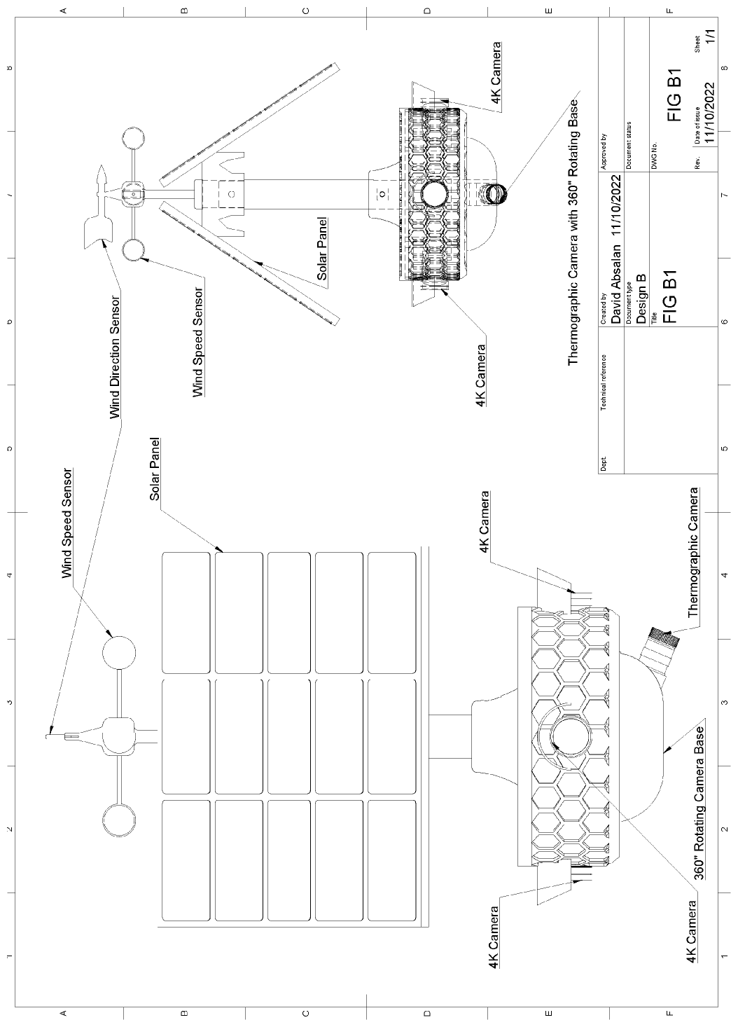

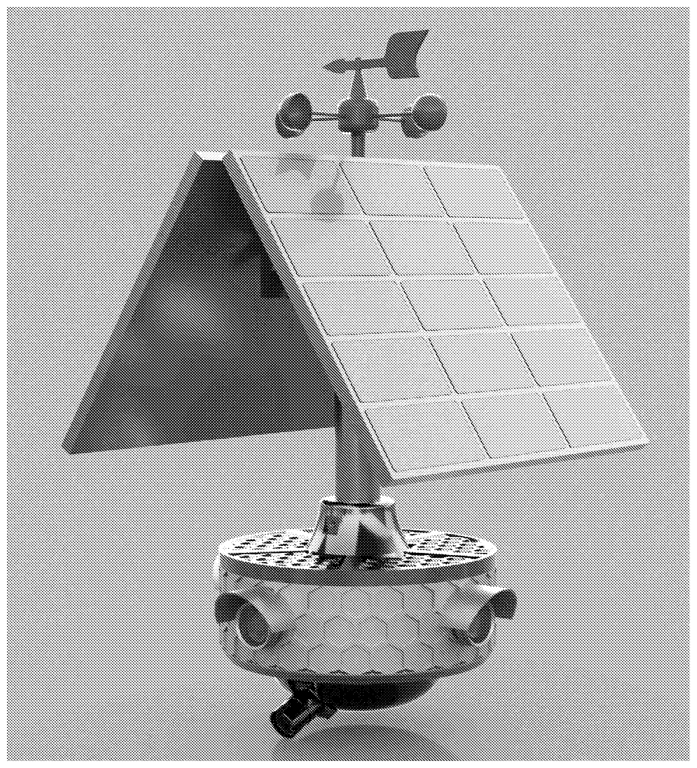

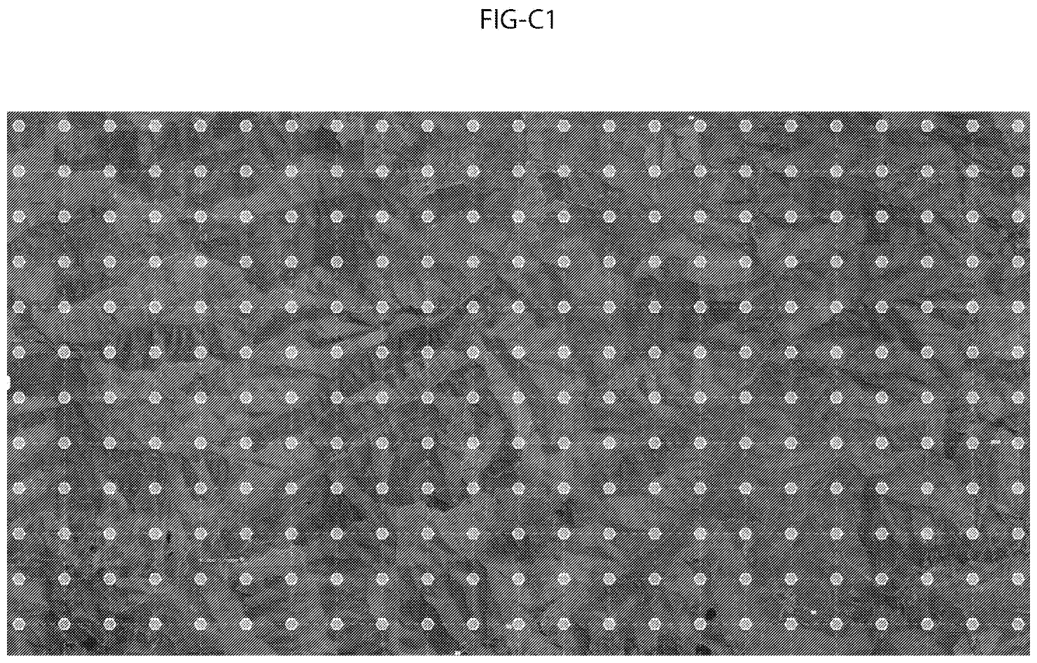

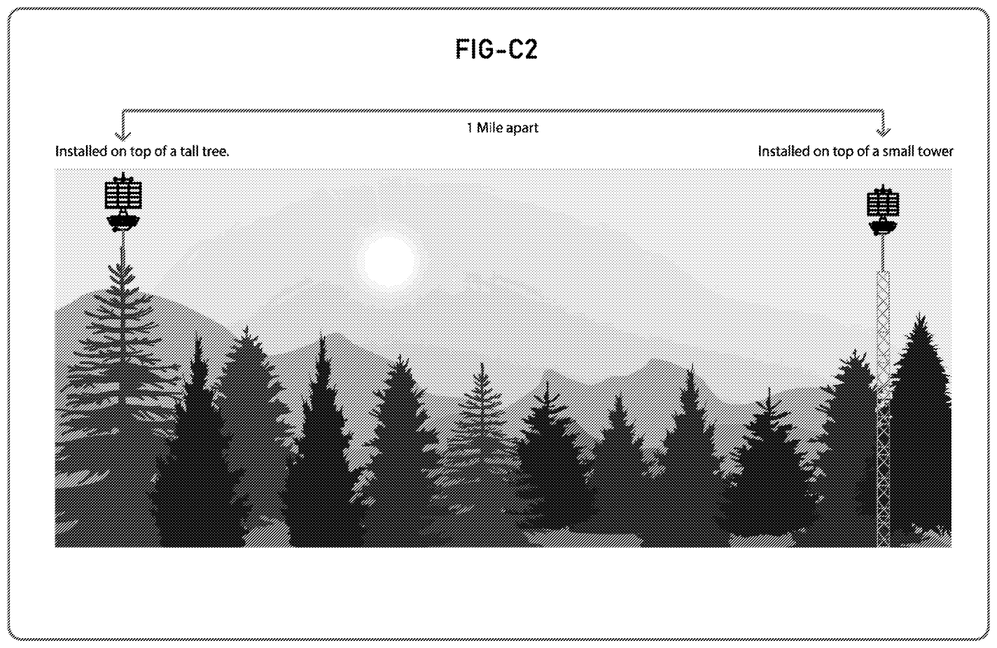

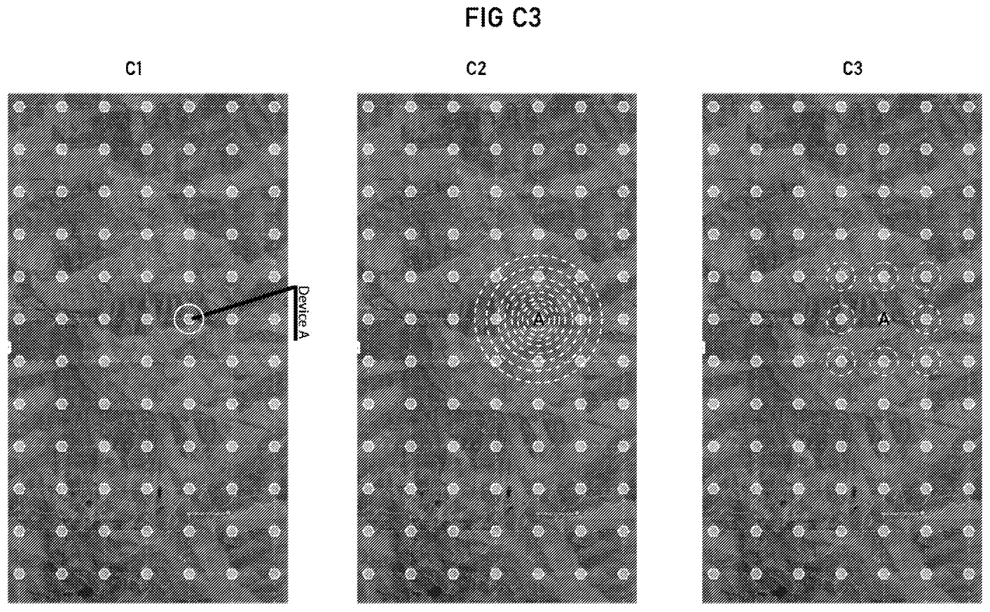

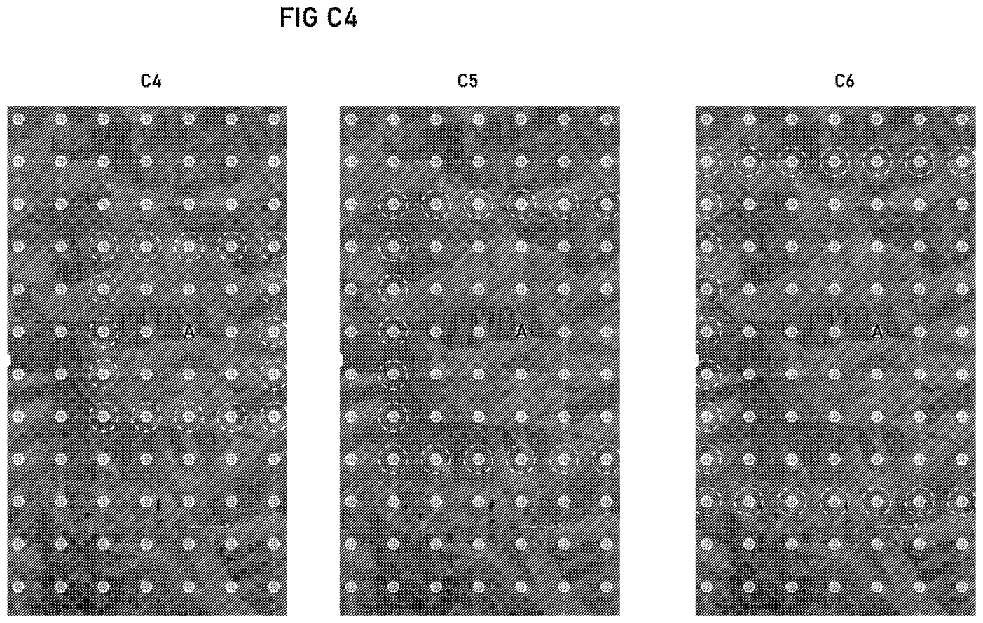

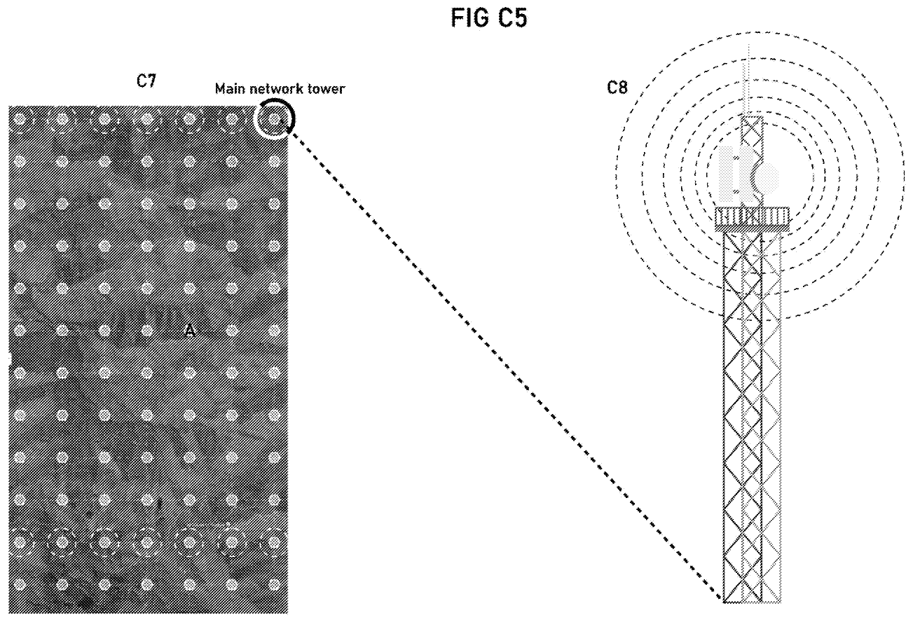

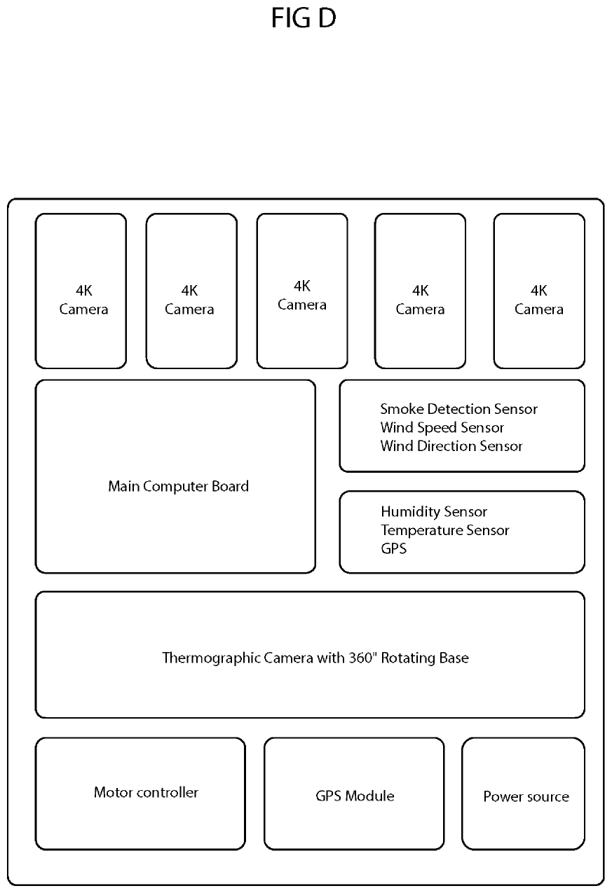

### CROSS-REFERENCE TO RELATED APPLICATIONS

This application claims the benefit of U.S. Provisional Patent Application No. 63/123,456, filed on Jan. 6, 2023 entitled Early wildfire detection and monitoring system and radio communication system.” The entirety of the aforementioned provisional application is hereby incorporated by reference for all purposes.

### Other References

U.S. Pat. No. 11,533,726 B2
US 2022/0398840 A1
U.S. Pat. No. 11,521,479 B2

### FIELD OF INVENTION

The present invention relates generally to systems and methods for wildfire detection and monitoring. More specifically, the invention pertains to a distributed network of intelligent wildfire detection devices that utilize image analysis, thermographic sensing, and inter-device communication for early detection and rapid transmission of wildfire alerts. The system features cost-effective and energy-efficient signal propagation without relying on traditional cellular or satellite communications.

### BACKGROUND INFORMATION

Current wildfire detection technologies often rely on satellite or cellular communication, limiting their coverage in remote areas and creating high operational costs. This leaves vast forests and wilderness areas vulnerable to undetected wildfires, leading to significant environmental and economic damage.

### History:

In 2021, a little over seven million acres were burned by nearly 59,000 wildfires. In 2020, about the same number of wildfires burned over 10 million acres, constituting the second most acreage affected by wildfires in a single year since 1960. Since 2000, an annual average of seven million acres has burned, reflecting the rapid proliferation of wildfires across the country.

As of August 2022, 48,211 wildfires have burned nearly 6.2 million acres, on track to surpass last year's devastation.

Property loss and damage is one of the primary effects of wildfires. A fire occurs in a structure every 64 seconds across the U.S., although outdoor fires remain more common. In total, fires in the U.S. in 2020 caused $21.9 billion in property damage.

The largest wildfires may cause well over $1 billion in property loss and damage individually—the costliest wildfire in U.S. history, 2018's Camp Fire, resulted in a loss of about $10 billion at the time. Eight of the 10 costliest wildfires ever in the U.S. have taken place in the past four years.

The U.S. outdoor recreation economy was nearly $374 billion in 2020, roughly 1.8% of the national GDP.

Wildfires not only have the potential to wipe out outdoor areas that draw in tourists but also to drive people away for years to come.

Forests act as the carbon sink by absorbing the atmospheric carbon-dioxide and thus reducing the concentrations of this toxic gas in the atmosphere. The occurrence of wildfires thus destroys the beneficial plant cover which in turn adversely affects the carbon sequestration and storage.

Smoke and ash released during fires can pollute the atmosphere with toxic gases and particles. As an after-effect of a wildfire, the loss of plants can also lead to the erosion of the soil and the contamination of water bodies by the eroded soil and dead plant and animal matter.

Wildfire caused the loss of thousands of lives. six people were killed in a wildfire as recently as July 2018 in northern California. The deadliest wildfires have accounted for over 1,000 lives lost.

It's extremely important to control and prevent wildfire to keep the planet livable for future generations.

The main issue is when a wildfire starts, it won't be detected for hours and in some cases for days until the fire is too big to be controlled easily.

### DETAILED DESCRIPTION OF THE INVENTION

This invention pertains to an advanced system designed for the early detection and initiation of response measures for potential wildfires, utilizing cutting-edge image processing and communication technologies. The primary objective of this system is to identify wildfires at their inception, aiming to halt their expansion to unmanageable proportions, thereby significantly reducing the extensive costs associated with conventional wildfire management strategies.

The system is equipped with multiple (four to five) high-resolution cameras, configured to capture images at one-minute intervals. These images are then forwarded to a central processing unit, which employs sophisticated artificial intelligence (AI) and machine learning algorithms for the meticulous analysis of each image for potential indicators of fire or smoke. This comprehensive analysis is achieved through the application of several algorithms, ensuring the delivery of precise and reliable data.

Upon identification of images with a high likelihood of fire or smoke presence, the system proceeds to verify these findings by assessing current weather conditions, including temperature and humidity, and activating smoke detection sensors. This multi-faceted approach enhances the accuracy of fire hazard identification. Following this, the system activates a thermographic camera mounted on a rotatable base, directing it towards the area flagged by the initial cameras. This camera captures detailed thermographic images, employing various zoom levels to meticulously examine the area of interest.

The AI and machine learning framework evaluates the thermographic images to corroborate the initial detection of fire. Upon confirmation, the system generates a Code Yellow alert, which includes the GPS coordinates of the detected fire, an estimate of the fire's extent, a unique identifier, relevant weather data, and a high-resolution image of the identified fire, transmitted via a radio transceiver module. The Code Yellow alert signifies a preliminary fire detection, pending verification by adjacent devices within the network.

Each device within the network is continuously scanning for new alerts. Upon receiving a Code Yellow signal, devices within the proximity of the reported location initiate their diagnostic protocols, capturing visual and thermographic images to validate the presence of a wildfire. Adjustments to the thermographic camera's zoom and focus are autonomously managed by the AI to optimize image quality and diagnostic accuracy.

Once a wildfire's presence is confirmed, the system escalates the alert to Code Red, indicating a verified wildfire. This alert encompasses the wildfire's GPS location, comprehensive weather data, wind direction and projections concerning the fire's potential spread, accompanied by high-resolution imagery of the affected area. The Code Red signal is propagated through the network until it reaches the Control Hub Tower, which relays the information to the nearest fire stations via GSM connectivity, supplemented by automated phone calls and visual data presented on a central monitoring application, showcasing the wildfire's location on a map.

In summary, this invention introduces a highly effective, automated solution for the early detection and response to wildfires, ensuring rapid and informed intervention to minimize damage and loss.

### BRIEF DESCRIPTION OF THE DRAWINGS

FIG A1: This is a compact design of the invention with different view. On this design the wind speed and wind direction sensor has been removed for the purpose of the device size.

FIG A2: 3D model of design A.

FIG B1: This design B and the main design and it has wind speed sensor and wind direction sensor.

FIG B2: 3D model of the design B

FIG C1: This map shows the installed devices each 1 mile apart.

FIG C2: Shows in close picture of the installation devices. The device can be installed on its own tower, on top of a tall tree or on available electric towers in the area if they are on the 1-mile range of other devices.

FIG C3-C1: This shows the device A has detected a potential wildfire.

FIG C3-C2: Device A transmitted the Code yellow message signal to all the surrounding devices. 8 surrounding devices have detected the Code yellow signal and started the analyzing process. The closest device to the wildfire location will do the final analyzing and transmits back confirmation to device A. Device A will repeat the step a which captures the pictures and analyze them for final stage and finally transmitted the Code Red signal message.

FIG C3-C3: All 8 surrounding devices get the Code Red message signal, and each device will transmit the same message signal out.

FIG C4-C4: All surrounding devices will receive the message signal and they will transmit the message signal out as well. The devices which already received and sent the signal will do nothing to maintain the device energy.

FIG C4-C5 to C6: The Code Red signal message will be received and transmitted by each device. This process will continue till the last device in the area.

FIG C5-C7: The Code Red signal message will reach the main tower hub which is a device with GSM and internet connection. When the message received, the main tower hub will send the received data to the main application server. The Application will send out the data to the closest Fire station to the detected wildfire location as well as a phone call with the same information to make sure an appropriate action will be taken.

FIG D: This drawing shows the individual component of the device which includes multiple 4k high resolution camera, main computer board, smoke detection sensor, wind speed sensor, wind direction sensor, humidity sensor, temperature sensor, thermographic camera, motor controller, GPS module, Power source.

1: A method for signal-based communication within a Wildfire Detecting Device System (WDDS), comprising:
Deploying a plurality of devices across a designated geographic area, wherein each device is configured to receive and transmit wildfire warning signals radio signal messages autonomously;
Establishing a mesh network among said devices, enabling signal transmission over extensive areas without reliance on GSM networks or satellite communication;
Implementing an energy-efficient protocol wherein upon receiving a signal message, a device transmits said message to adjacent devices, facilitating a sequential relay of the message throughout the network;
Ensuring comprehensive coverage across diverse terrains, including forest lands, mountains, and valleys, for the detection and monitoring of wildfires.

2: A method for detecting potential wildfires in forested areas, comprising:
Utilizing a combination of multiple high-resolution optical and thermographic cameras to capture detailed visual and thermal imagery of the terrain;
Analyzing the collected imagery with advanced machine learning and artificial intelligence algorithms designed to identify indicators of wildfires;
Transmitting imagery indicative of potential wildfires to a central monitoring system for verification, wherein the verification process includes manual confirmation by personnel at a fire station or the main monitoring system;
Enabling real-time monitoring and rapid response capabilities through the integration of said cameras and analytical techniques.

3: A method for optimizing the surveillance capabilities of a thermographic camera within a wildfire detection system, comprising:
Implementing artificial intelligence algorithms to control the positioning and focal adjustments of the thermographic camera dynamically;
Analyzing real-time data to identify specific areas of interest within a forest or vegetation-covered terrain;
Automatically adjusting the camera's zoom and orientation to capture detailed thermographic images of identified points of interest, facilitating precise monitoring and early detection of abnormal thermal activity indicative of a wildfire.
